(19) United States
(12) Patent Application Publication
(10) Pub. No.: US 2021/0051487 A1
(43) Pub. Date: Feb. 18, 2021

(54) Network Camera and Camera System of Wireless Mesh Network

(71) Applicant: Realtek Semiconductor Corp., HsinChu (TW)

(72) Inventors: Mingming Wu, Suzhou City (CN); Yanpeng Niu, Suzhou City (CN); Linlin Yu, Nantong City (CN)

(21) Appl. No.: 16/736,827

(22) Filed: Jan. 8, 2020

(30) Foreign Application Priority Data
Aug. 14, 2019 (CN) 201910749495.0

(51) Int. Cl. H04W 16/26; H04N 7/18

(52) U.S. Cl. CPC H04W 16/26; H04W 84/18; H04N 7/183

(57) ABSTRACT

A network camera includes a lens for capturing images, and a transmission circuit coupled to the lens. The transmission circuit includes a storage circuit for storing at least one code, and a processing circuit for executing the at least one code to perform following operations: connecting wirelessly to a wireless device via a wireless network, connecting wirelessly to another network camera via a wireless mesh network, bridging the wireless mesh network with the wireless network, receiving a set of data transmitted from the another network camera via the wireless mesh network, and transmitting the set of data to the wireless device via the wireless network.

### BACKGROUND OF THE INVENTION

### 1. Field of the Invention

The present disclosure is related to a network camera and a camera system, especially to a network camera and a camera system combining the traditional wireless network and the wireless mesh network.

### 2. Description of the Prior Art

Wireless mesh network is a type of wireless network that supports multi-point to multi-point. Wireless mesh network is a new type of broadband wireless network standard. It has inherited some new network technology for wireless local area networks technology. Wireless mesh network is a “multi-hop” network and one of the key technologies to solve the last-mile problem. Wireless mesh network is a high capacity and high speed distributed network. It is different from the traditional wireless network and can be regarded as a fusion of wireless local area network and Ad hoc network. The wireless mesh network is actually a reliable, wide-coverage wireless local area network that is ideal for covering large open areas (both outdoor and indoor). It has the advantages of broadband high speed and high spectral efficiency and can achieve dynamic self-organization, self-configuration and self-maintenance. Therefore, the characteristics of the wireless mesh network are very suitable for smart home (such as smart speakers, smart home appliances, etc.), smart city, schools and public security monitoring, etc.

A traditional wireless network camera can only be used as a network client. It does not have the wireless mesh network function that complies with IEEE 802.11s. A typical network camera has a wireless client module connected to the Internet or regional network via a wireless access point. A star topology is formed between each network camera and the wireless access point. This network topology allows only one link between each device and the wireless access point. If the link is disconnected due to poor wireless signals, the device cannot transmit data correctly. Moreover, all network cameras must be deployed within the signal coverage of the wireless access point, which limits the surveillance area of the network camera system. Therefore, providing a network camera and a camera system that can dynamically adjust connection to the wireless access point and further expand the signal coverage without increasing the hardware cost is an urgent demand.

### SUMMARY OF THE INVENTION

The embodiment provides a network camera including a lens for capturing images, and a transmission circuit coupled to the lens. The transmission circuit includes a storage circuit for storing at least one code, and a processing circuit for executing the at least one code to perform following operations: connecting wirelessly to a wireless device via a wireless network, connecting wirelessly to another network camera via a wireless mesh network, bridging the wireless mesh network with the wireless network, receiving a set of data transmitted from the another network camera via the wireless mesh network, and transmitting the set of data to the wireless device via the wireless network.

The embodiment provides a network camera including a lens for capturing images, and a transmission circuit coupled to the lens. The transmission circuit includes a wireless mesh network module wirelessly connected to another network camera via a wireless mesh network, and a wireless client module wirelessly connected to a wireless device via a wireless network. The wireless mesh network module receives a set of data transmitted by the another network camera via the wireless mesh network, and the wireless client module transmits the set of data to the wireless device via the wireless network.

The embodiment provides a network camera system including a first network camera and a second network camera. The first network camera includes a first lens for capturing images and generating image data, and a first transmission circuit for transmitting first set of data according to the image data via a wireless mesh network. The second network camera includes a storage circuit for storing at least one code, and a processing circuit for executing the at least one code to perform following operations: connecting wirelessly to a wireless device via a wireless network, connecting wirelessly to the first network camera via the wireless mesh network, bridging the wireless mesh network with the wireless network, receiving the first set of data transmitted from the first network camera via the wireless mesh network, and transmitting the first set of data to the wireless device via the wireless network.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a network camera according to an embodiment of the present disclosure.

FIG. 2 is a diagram of the functions according to a network camera of an embodiment of the present disclosure.

FIG. 3 is a diagram of a network camera system according to an embodiment of the present disclosure.

FIG. 4 is a flowchart of an image transmission method according to an embodiment of the present disclosure.

### DETAILED DESCRIPTION

The purpose of this case is to provide a network camera that supports wireless mesh network function. Its wireless network module can provide both client mode and wireless mesh mode, enabling the network camera to connect to other wireless devices supporting the wireless mesh network. This provides a more reliable data transmission (such as image data) , establishes a wireless mesh network, and makes the deployment of network cameras more flexible, no longer limited by signal coverage of the wireless access points.

Referring to FIG. 1, FIG. 1 is a diagram of a network camera 100 according to an embodiment of the present disclosure. The network camera 100 includes a lens 20 and a transmission circuit 30. The lens 20 is coupled to the transmission circuit 30 and is for capturing images and generating image data. The transmission circuit 30 is for processing the image data output by the lens 20 and wirelessly transmitting the processed image data.

In some embodiments, the transmission circuit 30 can include a wireless signal circuit. The wireless signal circuit can be used to encapsulate and decapsulate the transmitted data, to perform error control for transmitted data, encrypt and decrypt transmitted data, and to convert digital data to radio frequency signal or vice versa. In some embodiments, the wireless signal circuit can also be an independent circuit coupled to the transmission circuit 30.

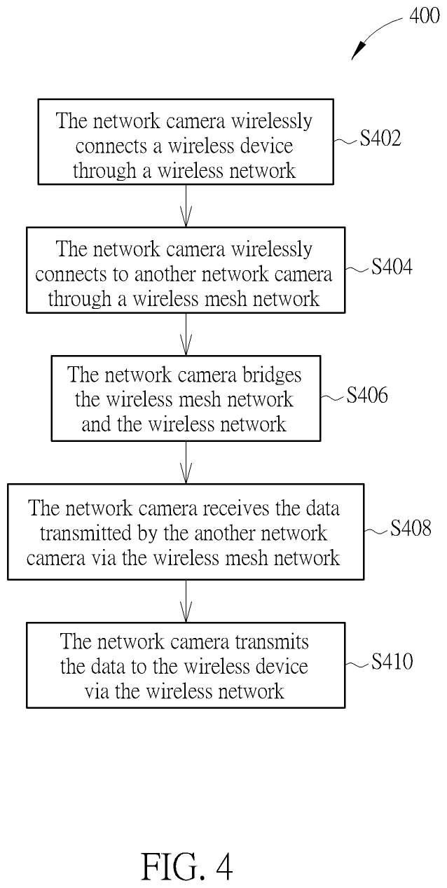

The transmission circuit 30 includes a processing circuit 40 and a storage circuit 50. The processing circuit 40 is coupled to the storage circuit 50, and is configured to execute the code stored in the storage circuit 50 to implement the image transmission method 400 as shown in FIG. 4. In some embodiments, the processing circuit 40 may be implemented with at least one processor circuit, a central processing unit (CPU), an application specific integrated circuit (ASIC), a multi-processor, a distributed processing system, or a suitable processing circuit. The various circuits or units for implementing the processing circuit 40 are within the scope of the present disclosure. In some embodiments, the storage circuit 50 is a non-transitory computer readable medium for storing codes of a plurality of instruction sets for checking a plurality of anti-interference circuits. For example, the storage circuit 50 stores a number of executable instructions to perform, for example, multiple steps in FIG. 4. In some embodiments, the non-transitory computer readable medium is an electrical, magnetic, optical, infrared, and/or semiconductor system (or apparatus or device). For example, non-transitory computer readable storage media include semiconductor or solid state memory, magnetic tape, removable computer diskettes, random access memory (RAM), read only memory (ROM), hard disk and/or optical magnetic disk. In one or more embodiments using the optical disk, the computer readable storage medium includes a CD-ROM, a CD-R/W, and/or a DVD.

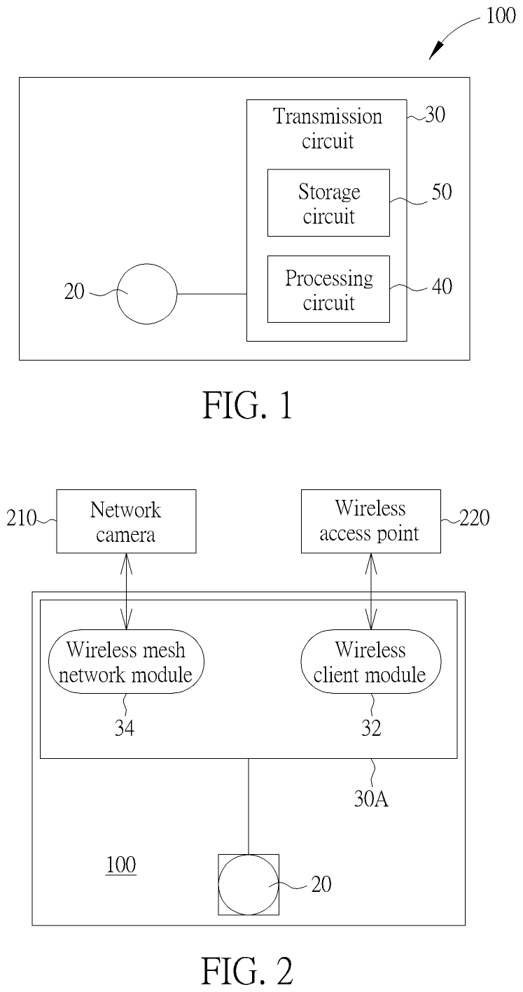

Referring to both FIGS. 1 and 2, FIG. 2 is a diagram of a network camera 100 according to an embodiment of the present disclosure. The network camera 100 includes a lens 20 and a transmission unit 30A. The transmission unit 30A includes a wireless client module 32 and a wireless mesh network module 34. The wireless client module 32 is for wirelessly connecting to a wireless access point 220, such as a wireless access point AP1 which supports the IEEE 802.11n or IEEE 802.11ax standards. The wireless mesh network module 34 is for wirelessly connecting to another network camera 210 to establish a wireless mesh network that supports the IEEE 802.11s standard. In some embodiments, the network interface provided by the wireless mesh network module 34 has dynamic routing functionality as defined by IEEE 802.11s. In some embodiments, the functions of the wireless client module 32 and the wireless mesh network module 34 may be provided by the processing circuit 40 in FIG. 1 to execute the code in the storage circuit 50. In other words, the wireless mesh network module 34 and the wireless client module 32 can be software modules.

In this embodiment, the network camera 100 is connected wirelessly to the network camera 210 and the wireless access point 220. The wireless mesh network formed by the network camera 100 connected to the network camera 210 can be connected to the Internet via the wireless access point 220. For example, after the image captured by the network camera 210 is converted to signals for wireless transmission, the image captured by the network camera 210 can be transmitted to the wireless access point 220 via the network camera 100 and transmitted to the regional network or the Internet via the wireless access point 220. This configuration makes the deployment of the wireless device more flexible. By deploying the network camera 100, the wireless signal coverage is expanded, and the deployment of the wireless device is no longer limited by the signal strength of the wireless access point 220 to the network cameras 100 and 210.

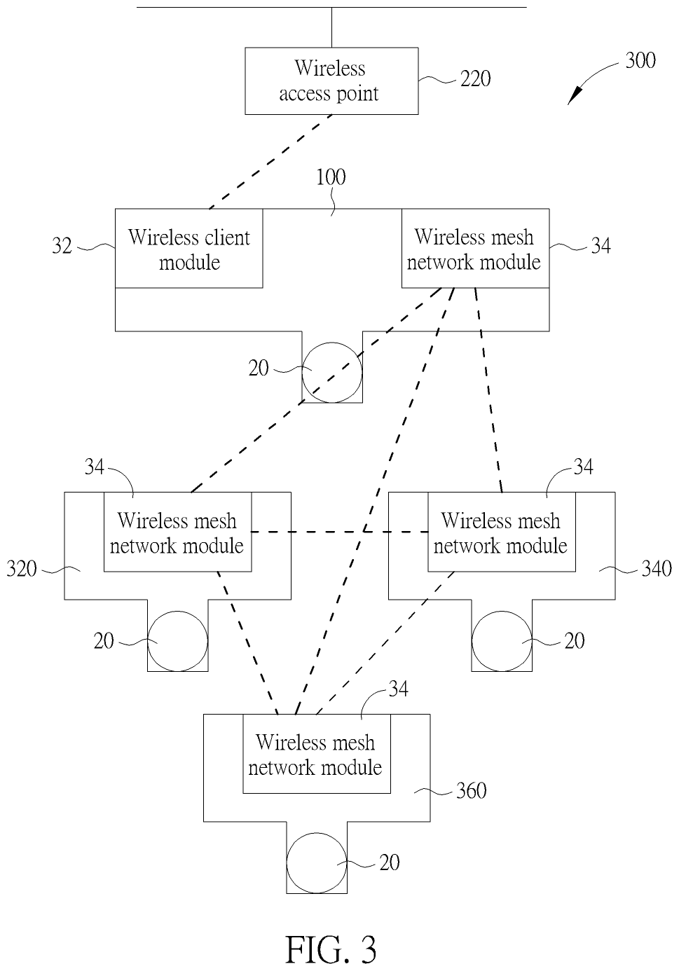

Referring to FIG. 3, FIG. 3 is a diagram of a wireless mesh network camera system 300 of an embodiment of the present disclosure. The wireless mesh network camera system 300 includes a plurality of network cameras 100, 320, 340, 360 that forma mesh network topology. The network camera 100 can have the wireless mesh network module 34 and the wireless client module 32. The network cameras 320, 340, 360 can have the wireless mesh network module 34. The network cameras 320, 340, and 360 can be wirelessly connected with the wireless mesh network module 34 of the network camera 100 to form the mesh network topology. This topology allows the network camera 360 to select multiple routes to communicate with the wireless access point 220. The following two examples demonstrate the routing. The first example: the network camera 360→the network camera 320→the network camera 100→the wireless access point 220. The second example: the network camera 360→the network camera 340→the network camera 100→the wireless access point 220. The network camera 360 can dynamically adjust the wireless link according to the Airtime link metric specified in the IEEE 802.11s standard and transmit the signals via a route with higher quality. If any of the paths in the routing of the first example is interrupted (for example, the connection between the network camera 360 and the network camera 320 is interrupted), the network camera 360 can still communicate with the wireless access point 220 through the routing of the second example to continue transmitting the signals. If the connection quality between the network camera 100 and the network camera 320 deteriorate for some reason, the network camera 340 can adjust the routing of the second example through the Airtime link metric, so as to increase the stability of the network camera system. For the routing of the second example, the image captured by the lens 20 of the network camera 360 is converted to an image signal for wireless transmission and then transmitted to the wireless mesh network module 34 of the network camera 340 via the wireless mesh network module 34 of the network camera 360. The wireless mesh network module 34 of the network camera 340, the wireless mesh network module 34 of the network camera 340 then forwards the image signal to the wireless mesh network module 34 of the network camera 100. The wireless mesh network module 34 of the network camera 100 receives the image signal and forwards it to the wireless access point 220 by the wireless client module 32 of the network camera 100. Finally, the image signal is transmitted to the regional network or the Internet via the wireless access point 220. In addition, the network camera 100 must be deployed within the wireless signal coverage of the wireless access point 220. The network camera 320 can be deployed outside the wireless signal coverage of the wireless access point 220 or within the coverage of the wireless mesh network signal of the network camera 100. The network camera 360 can be deployed in the wireless mesh network signal coverage of the network camera 320 according to need, so that the network camera can be deployed in a more flexible way without increasing the hardware cost. In this way, more extensive wireless signal coverage can be achieved. If the network camera 360 is deployed within the wireless mesh network signal coverage of the network camera 100, the network camera 360 can directly establish a wireless connection with the wireless access point 220 via the wireless mesh network module 34 of the network camera 100 and via either the network camera 320 or 340. In some embodiments, the network camera 320 can also be used to relay wireless transmission signals.

Referring to FIG. 4 as it illustrates an image transmission method performed by a network camera (such as the network camera 100), FIG. 4 is a flow chart illustrating an image transmission method 400 according to an embodiment of the present disclosure. The image transmission method 400 includes steps S402 to S410.

S402: The network camera wirelessly connects a wireless device through a wireless network;

S404: The network camera wirelessly connects to another network camera through a wireless mesh network;

S406: The network camera bridges the wireless mesh network and the wireless network;

S408: The network camera receives the data transmitted by the another network camera via the wireless mesh network;

S410: The network camera transmits the data to the wireless device via the wireless network.

In some embodiments of the image transmission method 400, the network camera can receive other sets of data from the wireless device via the wireless network, and transmit the data to another network camera through the wireless mesh network.

The wireless device may be the wireless access point 220 of FIG. 2 or FIG. 3. The network camera may be the network camera 100 of FIG. 1, FIG .2 or FIG. 3, and another network camera may be the network camera 320, the network camera 340 or the network camera 360 of FIG. 3.

In summary, the embodiment of the present disclosure provides a mesh network camera system capable of dynamically adjusting the route connecting the wireless access point without increasing the hardware cost. The network cameras do not need to be deployed within the wireless signal coverage of the wireless access point. Therefore the wireless signal coverage is expanded to form a more stable and higher quality network camera system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network camera comprising:
a lens, configured to capture images; and
a transmission circuit coupled to the lens, the transmission circuit comprising:
a storage circuit, configured to store at least one code; and
a processing circuit, configured to execute the at least one code to perform following operations:
connecting wirelessly to a wireless device via a wireless network;
connecting wirelessly to another network camera via a wireless mesh network;
bridging the wireless mesh network with the wireless network;
receiving a set of data transmitted from the another network camera via the wireless mesh network; and
transmitting the set of data to the wireless device via the wireless network.

2. The network camera of claim 1, wherein the network camera is disposed within a wireless signal coverage of the wireless device.

3. The network camera of claim 1, wherein the processing circuit is further configured to execute the at least one code to perform following operations:
receiving another set of data from the wireless device via the wireless network; and
transmitting the another set of data to the another network camera via the wireless mesh network.

4. The network camera of claim 1 is configured to support an IEEE 802.11s standard.

5. A network camera comprising:
a lens, configured to capture images; and
a transmission circuit coupled to the lens, comprising:
a wireless mesh network module, configured to connect wirelessly to another network camera via a wireless mesh network; and
a wireless client module, configured to connect wirelessly to a wireless device via a wireless network;
wherein the wireless mesh network module receives a set of data transmitted by the another network camera via the wireless mesh network, and the wireless client module transmits the set of data to the wireless device via the wireless network.

6. The network camera of claim 5, wherein the wireless mesh network module and the wireless client module are software modules.

7. The network camera of claim 5, wherein the wireless mesh network module has a routing function.

8. The network camera of claim 5, wherein the wireless mesh network module supports an IEEE 802.11s standard.

9. A network camera system, comprising:
a first network camera, comprising:
a first lens, configured to capture images and generate image data; and
a first transmission circuit, configured to transmit first set of data according to the image data via a wireless mesh network; and
a second network camera, comprising:
a storage circuit, configured to store at least one code; and
a processing circuit, configured to execute the at least one code to perform following operations:
connecting wirelessly to a wireless device via a wireless network;
connecting wirelessly to the first network camera via the wireless mesh network;
bridging the wireless mesh network with the wireless network;
receiving the first set of data transmitted from the first network camera via the wireless mesh network; and
transmitting the first set of data to the wireless device via the wireless network.

10. The network camera system of claim 9, wherein the second network camera is disposed within a wireless signal coverage of the wireless device.

11. The network camera system of claim 9, wherein the processing circuit is further configured to execute the at least one code to perform following operations:
receiving another set of data from the wireless device via the wireless network; and
transmitting the another set of data to the first network camera via the wireless mesh network.

12. The network camera system of claim 9, wherein the first network camera and the second network camera have routing function.

13. The network camera system of claim 9, wherein the first network camera and the second network camera support an IEEE 802.11s standard.
